(19) United States
(12) Patent Application Publication
(10) Pub. No.: US 2003/0051998 A1
(43) Pub. Date: Mar. 20, 2003

(54) Security control system for use in an oxyhydrogen fuel producing apparatus

(76) Inventors: Shun-Yi Lin, Hsinchu (TW); Show-Yih Ko, Taipei (TW); Shui-Yuan Lee, Lujou City (TW); Kung-Yu Lu, Taipei (TW); Jiunn-Yan Lee, Lujou City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/152,133

(22) Filed: May 21, 2002

(30) Foreign Application Priority Data
Sep. 14, 2001 (TW) 90215890

(51) Int. Cl. H01M 8/06; H01M 8/18; C25C 7/00; C25B 9/00; C25D 17/00; C25F 7/00

(52) U.S. Cl. 204/274; 429/21; 204/275.1

(57) ABSTRACT

A security control system for an oxyhydrogen fuel producing apparatus. The security control system includes a system control device, a first pressure control device, a second pressure control device, a temperature control device, a water level control device and a catalyst level control device to improve and ensure the security of the oxyhydrogen fuel producing apparatus.

### BACKGROUND OF THE INVENTION

1. Field of the Invention

The present invention relates to a security control system, and in particular to a security control system for use in an oxyhydrogen fuel producing apparatus.

2. Description of the Related Art

Generally speaking, in a conventional oxyhydrogen fuel producing apparatus, an electrobath is appled to electrolyze water contained therein to produce hydrogen and oxygen. Then, the hydrogen and oxygen are respectively delivered to a blowpipe by guide tubes. Thus, the blowpipe sprays the hydrogen and oxygen, forming an oxyhydrogen torch as an industrial cutting device or a heating device. In the aforementioned process, the water incompletely electrolyzed in the electrobath can be pumped out and transmitted through a heat dissipation device, such as a fan, to cool down the water, so that the water can be recycled for further electrolysis. Thus, the conventional oxyhydrogen fuel producing apparatus does not require a high-pressure steel cylinder.

The conventional oxyhydrogen fuel producing apparatus does not disclose a security control system. For example, when a power source is applied to the electrobath for electrolyzing water contained therein, the oxyhydrogen produced flows through an oxyhydrogen storage tank, a cooling tank and an anti-explosion device. A pressure gauge for measuring the pressure of oxyhydrogen is disposed outside the oxyhydrogen storage tank and controlled by a pressure controller. The cooling tank has a bypass pipe. The bypass pipe is filled with volatile materials for mixing with the oxyhydrogen such that the oxyhydrogen can be cooled down. The anti-explosion device is connected to a pressure regulator having another pressure gauge. The pressure regulator is connected to a blowpipe through a guide tube. The blowpipe sprays the hydrogen and oxygen to form an oxyhydrogen torch as an industrial fuel.

Meanwhile, the water incompletely electrolyzed in the electrobath can be pumped out by a pump disposed near the outlet of a heat dissipation pipe. The water, cooled down by a heat dissipation device, can be recycled to the electrobath for further electrolysis. In addition, the heat dissipation device also includes a fan.

As to the temperature control, plural temperature control switches are disposed on the lateral sides of the electrobath for controlling the operation of the fan of the heat dissipation device. The operation of the fan is stopped when the temperature control switches sense a temperature lower than a predetermined temperature.

As to electrolyte replenishment, the anti-explosion device is whirled to a water pouring pipe such that water can be poured into the electrobath by opening the anti-explosion device.

Under the situation of a sudden electric power cut, as the electrobath retains temperature, the electrolysis is still continued to produce the oxyhydrogen. At this time, the continuously produced oxyhydrogen cannot be expelled out and the oxyhydrogen pressure continues to rise to cause an explosion of the electrobath.

In another aspect, though the plural temperature control switches are disposed on the lateral sides of the electrobath for controlling the operation of the fan of the heat dissipation device and the fan is working, the oxyhydrogen fuel producing apparatus still can cause an explosion when the temperature of the electrobath continuously rises and there is no device which can cut off the electric power.

Further, when water is replenished to the oxyhydrogen fuel producing apparatus, the anti-explosion device is required to be opened and the operation of the oxyhydrogen fuel producing apparatus is required to be stopped such that water can be poured into the electrobath. Thus, the oxyhydrogen production is reduced.

### SUMMARY OF THE INVENTION

An object of the invention is to provide a security control system for use in an oxyhydrogen fuel producing apparatus having an electrobath, an electrolyte storage tank, an electrolyte replenishing tank, a catalyst storage tank, a catalyst replenishing tank and a cooling system having a fan and a heat dissipation device. The security control system comprises a first pressure control device disposed outside the electrobath for expelling the oxyhydrogen from the electrobath when the electric power of the oxyhydrogen fuel producing apparatus is cut off; a second pressure control device disposed outside the electrobath for expelling the oxyhydrogen from the electrobath when the security control system malfunctions; a temperature control device for sensing the temperature in the electrobath and outputting a corresponding temperature signal; a water level control device for sensing the water level in the electrobath and the electrolyte storage tank and outputting a corresponding water level signal; a catalyst level control device for sensing the catalyst level in the catalyst storage tank and outputting a corresponding catalyst level signal; and a system control device for receiving the temperature signal, the water level signal and the catalyst level signal and outputting corresponding control signals to the oxyhydrogen fuel producing apparatus.

A detailed description will be given by the following embodiments with reference to the accompanying drawings.

### BRIEF DESCRIPTION OF THE DRAWINGS

The present invention can be more fully understood by reading the subsequent detailed description and examples with references made to the accompanying drawing, wherein:

FIG. 1 shows a schematic view of the oxyhydrogen fuel producing apparatus of the invention.

### DETAILED DESCRIPTION OF THE INVENTION

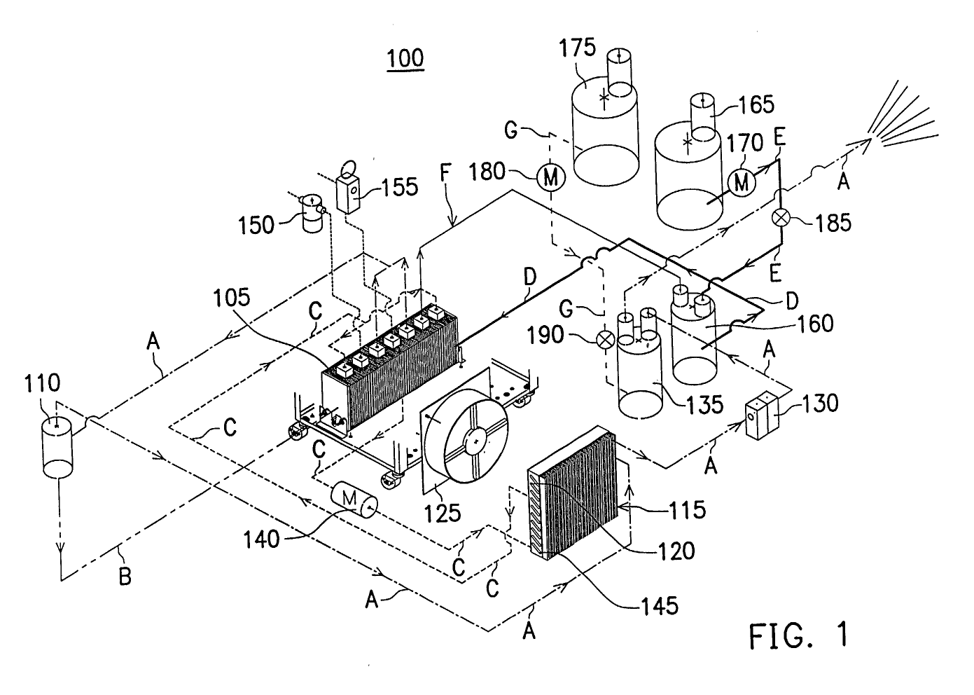

FIG. 1 shows the oxyhydrogen fuel producing apparatus 100. In the electrobath 105, water is electrolyzed into oxyhydrogen (oxygen and hydrogen). The oxyhydrogen is delivered to a filter tank 110 via route A. Water mixed in the oxyhydrogen is filtered off by the filter tank 110. The water filtered by the filter tank 110 is delivered back to the electrobath 105 via route B for further electrolysis. Meanwhile, the oxyhydrogen passing through the filter tank 110 is delivered to a heat dissipation device 115 via route A. The oxyhydrogen is cooled down in the gas heat dissipation tube 120 and the heat dissipation device 115 is further cooled by a fan 125. Then, the oxyhydrogen is delivered to a plurality of filter cans 130 via route A. In the heat dissipation device 115, moisture in the oxyhydrogen is condensed into water. Thus, the plurality of filter cans 130 are used to collect the condensed water to enhance the dry level of the oxyhydrogen. The oxyhydrogen is then delivered to a catalyst storage tank 135 via route A to mix with catalyst. The catalyst is used to lower the temperature of the oxyhydrogen to an applicable temperature and can be hexane or gasoline. Finally, the oxyhydrogen is output from the catalyst storage tank 135 to be applied.

As described above, an electromagnetic pressure release valve 150 is disposed outside the electrobath 105. Because the electrobath retains temperature when the electric power of the oxyhydrogen fuel producing apparatus 100 is cut off, the electrolysis still continues to produce the oxyhydrogen and the inner pressure of the electrobath 105 continuously rises. Thus, when the electric power of the oxyhydrogen fuel producing apparatus 100 is cut off, the electromagnetic pressure release valve 150 can automatically expel the oxyhydrogen from the electrobath until there is no oxyhydrogen in the electrobath.

In addition, a mechanical pressure release valve 155 is disposed outside the electrobath 105. When the oxyhydrogen fuel producing apparatus 100 is in operation and the security control system malfunctions, for example, the oxyhydrogen produced in the electrobath 105 cannot be output via route A, the mechanical pressure release valve 155 can expel oxyhydrogen from the electrobath 105. The mechanical pressure release valve 155 is predetermined with a maximum pressure value. When the oxyhydrogen pressure value in the electrobath 105 exceeds the maximum pressure value of the mechanical pressure release valve 155, the oxyhydrogen enforces the mechanical pressure release valve 155 to be opened such that the oxyhydrogen can be expelled.

Also referring to FIG. 1, the electrolyte in the electrobath 105 is pumped to the heat dissipation device 115 by a motor 140 and via route C. The electrolyte flows back to the electrobath 105 for further electrolysis after it is cooled down through the electrolyte heat dissipation tube 145. The electrolyte heat dissipation tube 145 is also cooled down by the fan 125. Specifically, the cooling of the electrolyte and the oxyhydrogen is integrally combined in the same cooling system. Thus, the cooling efficiency of the oxyhydrogen can be enhanced, and the total volume and the manufacturing cost of the oxyhydrogen fuel producing apparatus 100 can be reduced.

Still referring to FIG. 1, the oxyhydrogen fuel producing apparatus 100 also includes an electrolyte storage tank 160 and an electrolyte replenishing tank 165. The electrolyte (water) flows from the electrolyte storage tank 160 to the electrobath 105 via route D. The route D is a horizontal pipe connected between the electrolyte storage tank 160 and the electrobath 105.

The following description will explain the operation of the water level control device. The water level control device comprises a high water level switch (not shown), a middle water level switch (not shown) and a low water level switch (not shown). The water level switches are respectively connected to a sensor (not shown) disposed in the electrolyte storage tank 160 for sensing the water level in the electrolyte storage tank 160. The water level switches are controlled by a system control device (not shown). As the electrolyte storage tank 160 is connected to the electrobath 105 with the horizontal pipe D, when the water level in the electrolyte storage tank 160 is at a middle water level, the sensor of the middle water level switch outputs a fourth signal to the system control device. Then, the system control device outputs a corresponding signal to actuate a motor 170 disposed between the electrolyte storage tank 160 and the electrolyte replenishing tank 165 to pump water from the electrolyte replenishing tank 165 to the electrolyte storage tank 160 via route E. When water is replenished to a high water level, the sensor of the high water level switch outputs a fifth signal to the system control device. Then, the system control device outputs a corresponding signal to shut down the motor 170 to stop pumping water to the electrolyte storage 160. In addition, in case the motor 170 malfunctions or there is no water in the electrolyte replenishing tank 165, the water in the electrolyte replenishing tank 165 is continuously consumed until the water level is at a low level. The sensor of the low water level switch outputs a sixth signal to the system control device. Then, the system control device outputs a corresponding signal to cut off the electric power of oxyhydrogen fuel producing apparatus 100 so as to avoid a serious disaster resulting from the high temperature of the electrobath 105. From the aforementioned description, the oxyhydrogen fuel producing apparatus 100 of this embodiment can be replenished with water without cutting off the electric power, thus enhancing the production efficiency of the oxyhydrogen. Further, when the electric power of the oxyhydrogen fuel producing apparatus 100 is cut off, a buzzer (not shown) disposed therein can send out a warning to notify the operator of this incident.

In addition, in the route E, i.e. in the electrolyte replenishing pipe, a first irreversible valve 185 is disposed to prevent gas and water from flowing back to the electrolyte replenishing tank 165.

The aforementioned automatic water replenishing system also comprises a control circuit (not shown) connected to the system control device. When the oxyhydrogen fuel producing apparatus 100 starts to work, the control circuit inspects the water level in the electrobath 105 to judge the water level. When the water in the electrobath 105 is replenished to a suitable level, the oxyhydrogen fuel producing apparatus 100 starts to electrolyze the water.

In addition, the route F as shown in FIG. 1 is a pipe connected between the electrobath 105 and the electrolyte storage tank 160. The pipe F is used to balance the gas pressure in the electrobath 105 and the electrolyte storage tank 160.

The following description will explain the operation of the temperature control device. The temperature device comprises a high temperature switch (not shown), a middle temperature switch (not shown) and a low temperature switch (not shown). The temperature switches respectively have a corresponding sensor (not shown) disposed in route C in which the electrolyte flows. The three sensors are connected to the system control device and used to sense the temperature in the electrobarh 105. When the temperature of the electrolyte exceeds 50° C., the sensor of the middle-temperature switch outputs a first signal to the system control device. Then, the system control device outputs a corresponding signal to actuate the fan 125 to cool the electrolyte. However, the electrolyte can not be cooled unlimitedly such that the electrolysis is not slowed down and the oxyhydrogen production is not reduced. When the temperature of the electrolyte is reduced to 40° C., the sensor of the low-temperature switch outputs a second signal to the system control device. Then, the system control device outputs a corresponding signal to shut down the fan 125. When the fan 125 is working and the temperature of the electrolyte exceeds 80° C., the sensor of the high-temperature switch outputs a third signal to the system control device. Then, the system control device outputs a corresponding signal to cut off the electric power of the oxyhydrogen fuel producing apparatus 100. Similarly, when the electric power of the oxyhydrogen fuel producing apparatus 100 is cut off, the buzzer can send out a warning to notify the operator.

The following description explains the operation of the catalyst level control device. The catalyst level control device comprises a high catalyst level switch (not shown), a middle catalyst level switch (not shown) and a low catalyst level switch (not shown). The switches respectively have a corresponding sensor (not shown) disposed in the catalyst storage tank 135 for sensing the catalyst level. The three sensors are connected to the system control device. When the catalyst level in the catalyst storage tank 135 is at a low catalyst level, the sensor of the middle catalyst level switch outputs a seventh signal to the system control device. Then, the system control device outputs a corresponding signal to actuate a motor 180 disposed between the catalyst storage tank 135 and the catalyst replenishing tank 175 to pump the catalyst from the catalyst replenishing tank 175 to the catalyst storage tank 135 via route G. When the catalyst is replenished to a high catalyst level in the catalyst storage tank 135, the sensor of the high catalyst level outputs an eighth signal to the system control device. Then, the system control device outputs a corresponding signal to shut down the motor 180 to stop pumping catalyst to the catalyst storage tank 135. In case the motor 180 malfunctions or the catalyst level in the catalyst storage tank 135 is at a low catalyst level, the sensor of the low catalyst level switch outputs a ninth signal to the system control device. Then, the system control device outputs a corresponding signal to cut off the electric power of the oxyhydrogen fuel producing apparatus 100. Similarly, when the electric power of the oxyhydrogen fuel producing apparatus 100 is cut off, the buzzer can send out a warning to notify the operator.

In addition to the above detailed description, there is a second irreversible valve 190 disposed in the route G. The second irreversible valve 190 is used to prevent the catalyst from flowing back to the catalyst replenishing tank 175.

While the invention has been described by way of example and in terms of the preferred embodiment, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A security control system for use in an oxyhydrogen fuel producing apparatus having an electrobath, an electrolyte storage tank, an electrolyte replenishing tank, a catalyst storage tank, a catalyst replenishing tank and a cooling system having a fan and a heat dissipation device, comprising:
a first pressure control device disposed outside the electrobath for expelling the oxyhydrogen from the electrobath when the electric power of the oxyhydrogen fuel producing apparatus is cut off;
a second pressure control device disposed outside the electrobath for expelling the oxyhydrogen from the electrobath when the security control system malfunctions;
a temperature control device for sensing the temperature in the electrobath and outputting a corresponding temperature signal;
a water level control device for sensing the water level in the electrobath and the electrolyte storage tank and outputting a corresponding water level signal;
a catalyst level control device for sensing the catalyst level in the catalyst storage tank and outputting a corresponding catalyst level signal; and
a system control device for receiving the temperature signal, the water level signal and the catalyst level signal and outputting corresponding control signals to the oxyhydrogen fuel producing apparatus.

2. The security control system as claimed in claim 1, wherein the first pressure control device further comprises an electromagnetic pressure release valve disposed outside the electrobath for expelling the oxyhydrogen from the electrobath when the electric power of the oxyhydrogen fuel producing apparatus is cut off.

3. The security control system as claimed in claim 1, wherein the first pressure control device further comprises a normal open electromagnetic pressure release valve disposed outside the electrobath for expelling the oxyhydrogen from the electrobath when the electric power of the oxyhydrogen fuel producing apparatus is cut off.

4. The security control system as claimed in claim 1, wherein the second pressure control device further comprises at least one mechanical pressure release valve disposed outside the electrobath for expelling the oxyhydrogen from the electrobath when the security control system malfunctions.

5. The security control system as claimed in claim 1, wherein the temperature device further comprises a high temperature switch, a middle temperature switch and a low temperature switch, the temperature switches respectively having a corresponding sensor disposed in a pipe in which the electrolyte flows and connected to the system control device, the sensor of the middle-temperature switch outputting a first signal to the system control device and the system control device outputting a corresponding signal to actuate the fan when the temperature in the electrobath exceeds a first temperature, the sensor of the low-temperature switch outputting a second signal to the system control device and the system control device outputting a corresponding signal to shut down the fan when the temperature in the electrobath is lower than a second temperature, and the sensor of high-temperature switch outputting a third signal to the system control device and the system control device outputting a corresponding signal to cut off the electric power of the oxyhydrogen fuel producing apparatus when the temperature in the electrobath exceeds a third temperature.

6. The security control system as claimed in claim 1, wherein the water level control device further comprises a high water level switch, a middle water level switch and a low water level switch, the water level switches respectively having a corresponding sensor disposed in the electrolyte storage tank for sensing the water level in the electrolyte storage tank and the electrobath and connected to the system control device, the sensor of the middle water level switch outputting a fourth signal to the system control device and the system control device outputting a corresponding signal to actuate a first motor disposed between the electrolyte storage tank and the electrolyte replenishing tank to pump water from the electrolyte replenishing tank to the electrolyte storage tank when the water level in the electrolyte storage tank is at a first water level, the sensor of the high water level switch outputting a fifth signal to the system control device and the system control device outputting a corresponding signal to shut down the first motor to stop pumping water from the electrolyte replenishing tank to the electrolyte storage tank when the water level in the electrolyte storage tank is at a second water level, and the sensor of the low water level switch outputting a sixth signal to the system control device and the system control device outputting a corresponding signal to cut off the electric power of oxyhydrogen fuel producing apparatus when the water level in the electrolyte storage tank is at a third water level.

7. The security control system as claimed in claim 1, wherein the electrobath is connected to the electrolyte storage tank through a horizontal electrolyte replenishing pipe such that the sensors of the water level switches in the electrolyte storage tank can sense the water level of the electrobath.

8. The security control system as claimed in claim 1, wherein the catalyst level control device further comprises a high catalyst level switch, a middle catalyst level switch and a low catalyst level switch, the switches respectively having a corresponding sensor disposed in the catalyst storage tank for sensing the catalyst level and connected to the system control device, the sensor of the middle catalyst level switch outputting a seventh signal to the system control device and the system control device outputting a corresponding signal to actuate a second motor disposed between the catalyst storage tank and the catalyst replenishing tank to pump the catalyst from the catalyst replenishing tank to the catalyst storage tank when the catalyst level in the catalyst storage tank is at a first catalyst level, the sensor of the high catalyst level outputting an eighth signal to the system control device and the system control device outputting a corresponding signal to shut down the second motor to stop pumping catalyst from the catalyst replenishing tank to the catalyst storage tank when the catalyst level in the catalyst storage tank is at a second catalyst level, and the sensor of the low catalyst level switch outputting a ninth signal to the system control device and the system control device outputting a corresponding signal to cut off the electric power of the oxyhydrogen fuel producing apparatus when the catalyst level in the catalyst storage tank is at a third catalyst level.

9. An oxyhydrogen fuel producing apparatus, comprising:
an electrobath for electrolyzing water to produce oxyhydrogen;
an automatic water replenishing system having an electrolyte replenishing tank and an electrolyte storage tank for automatically replenishing water to the electrobath when the water level in the electrobath is low;
an automatic catalyst replenishing system having a catalyst replenishing tank and a catalyst storage tank for automatically replenishing catalyst to the catalyst storage tank when the catalyst level in the catalyst storage tank is low;
a cooling system having a fan, an electrolyte heat dissipation pipe and a gas heat dissipation pipe for cooling the electrolyte flowing through the electrobath and the oxyhydrogen produced respectively;
a first pressure control device disposed outside the electrobath for expelling the oxyhydrogen from the electrobath when the electric power of the oxyhydrogen fuel producing apparatus is cut off;
a second pressure control device disposed outside the electrobath for expelling the oxyhydrogen from the electrobath when the oxyhydrogen fuel producing apparatus malfunctions;
a temperature control device for sensing the temperature in the electrobath and outputting a corresponding temperature signal;
a water level control device for sensing the water level in the electrobath and the electrolyte storage tank and outputting a corresponding water level signal;
a catalyst level control device for sensing the catalyst level in the catalyst storage tank and outputting a corresponding catalyst level signal;
a system control device for receiving the temperature signal, the water level signal, the catalyst level signal and the pressure signal and outputting the corresponding signals to the oxyhydrogen fuel producing apparatus respectively.

10. The oxyhydrogen fuel producing apparatus as claimed in claim 9, wherein the automatic water replenishing system further comprises a control circuit connected to the system control device for automatically sensing the water level in the electrobath before the oxyhydrogen fuel producing apparatus operates, the oxyhydrogen fuel producing apparatus operating after water is replenished to a predetermined water level.

11. The oxyhydrogen fuel producing apparatus as claimed in claim 9, wherein the automatic water replenishing system further comprises a first motor disposed in an electrolyte replenishing pipe connected between the electrolyte replenishing tank and the electrolyte storage tank for pumping water to the electrolyte storage tank from the electrolyte replenishing tank when water level in the electrobath is low.

12. The oxyhydrogen fuel producing apparatus as claimed in claim 11, wherein the first motor is controlled by the system control device.

13. The oxyhydrogen fuel producing apparatus as claimed in claim 11, wherein the electrobath is connected to the electrolyte storage tank through a horizontal electrolyte replenishing pipe.

14. The oxyhydrogen fuel producing apparatus as claimed in claim 11, wherein the electrolyte replenishing pipe connected between the electrolyte replenishing tank and the electrolyte storage tank further comprises a first irreversible valve for preventing the electrolyte and the oxyhydrogen from flowing back to the electrolyte replenishing tank.

15. The oxyhydrogen fuel producing apparatus as claimed in claim 9, wherein the automatic catalyst replenishing system further comprises a second motor disposed in a catalyst replenishing pipe connected between the catalyst replenishing tank and the catalyst storage tank for pumping catalyst to the catalyst storage tank from the catalyst replenishing tank when the catalyst level in the catalyst storage tank is low.

16. The oxyhydrogen fuel producing apparatus as claimed in claim 15, wherein the second motor is controlled by the system control device.

17. The oxyhydrogen fuel producing apparatus as claimed in claim 15, wherein the catalyst replenishing pipe further comprises a second irreversible valve for preventing catalyst from flowing back to the catalyst replenishing tank.

18. The oxyhydrogen fuel producing apparatus as claimed in claim 9, wherein the fan is controlled by the system control device.

19. The oxyhydrogen fuel producing apparatus as claimed in claim 9, wherein the first pressure control device further comprises an electromagnetic pressure release valve disposed outside the electrobath for expelling the oxyhydrogen from the electrobath when the electric power of the oxyhydrogen fuel producing apparatus is cut off.

20. The oxyhydrogen fuel producing apparatus as claimed in claim 9, wherein the first pressure control device further comprises a normal open electromagnetic pressure release valve disposed outside the electrobath for expelling the oxyhydrogen from the electrobath when the electric power of the oxyhydrogen fuel producing apparatus is cut off.

21. The oxyhydrogen fuel producing apparatus as claimed in claim 9, wherein the second pressure control device further comprises at least one mechanical pressure release valve disposed outside the electrobath for expelling the oxyhydrogen from the electrobath when the security control system malfunctions.

22. The oxyhydrogen fuel producing apparatus as claimed in claim 9, wherein the temperature device further comprises a high temperature switch, a middle temperature switch and a low temperature switch, the temperature switches respectively having a corresponding sensor disposed in a pipe in which the electrolyte flows and connected to the system control device, the sensor of the middle-temperature switch outputting a first signal to the system control device and the system control device outputting a corresponding signal to actuate the fan when the temperature in the electrobath exceeds a first temperature, the sensor of the low-temperature switch outputting a second signal to the system control device and the system control device outputting a corresponding signal to shut down the fan when the temperature in the electrobath is lower than a second temperature, and the sensor of high-temperature switch outputting a third signal to the system control device and the system control device outputting a corresponding signal to cut off the electric power of the oxyhydrogen fuel producing apparatus when the temperature in the electrobath exceeds a third temperature.

23. The oxyhydrogen fuel producing apparatus as claimed in claim 9, wherein the water level control device further comprises a high water level switch, a middle water level switch and a low water level switch, the water level switches respectively having a corresponding sensor disposed in the electrolyte storage tank for sensing the water level in the electrolyte storage tank and the electrobath and connected to the system control device, the sensor of the middle water level switch outputting a fourth signal to the system control device and the system control device outputting a corresponding signal to actuate a first motor disposed between the electrolyte storage tank and the electrolyte replenishing tank to pump water from the electrolyte replenishing tank to the electrolyte storage tank when the water level in the electrolyte storage tank is at a first water level, the sensor of the high water level switch outputting a fifth signal to the system control device and the system control device outputting a corresponding signal to shut down the first motor to stop pumping water from the electrolyte replenishing tank to the electrolyte storage tank when the water level in the electrolyte storage tank is at a second water level, and the sensor of the low water level switch outputting a sixth signal to the system control device and the system control device outputting a corresponding signal to cut off the electric power of oxyhydrogen fuel producing apparatus when the water level in the electrolyte storage tank is at a third water level.

24. The oxyhydrogen fuel producing apparatus as claimed in claim 9, wherein the catalyst level control device further comprises a high catalyst level switch, a middle catalyst level switch and a low catalyst level switch, the switches respectively having a corresponding sensor disposed in the catalyst storage tank for sensing the catalyst level and connected to the system control device, the sensor of the middle catalyst level switch outputting a seventh signal to the system control device and the system control device outputting a corresponding signal to actuate a second motor disposed between the catalyst storage tank and the catalyst replenishing tank to pump the catalyst from the catalyst replenishing tank to the catalyst storage tank when the catalyst level in the catalyst storage tank is at a first catalyst level, the sensor of the high catalyst level outputting an eighth signal to the system control device and the system control device outputting a corresponding signal to shut down the second motor to stop pumping catalyst from the catalyst replenishing tank to the catalyst storage tank when the catalyst level in the catalyst storage tank is at a second catalyst level, and the sensor of the low catalyst level switch outputting a ninth signal to the system control device and the system control device outputting a corresponding signal to cut off the electric power of the oxyhydrogen fuel producing apparatus when the catalyst level in the catalyst storage tank is at a third catalyst level.
